(19) United States
(12) Patent Application Publication
(10) Pub. No.: US 2021/0194390 A1
(43) Pub. Date: Jun. 24, 2021

(54) METHOD AND APPARATUS FOR GENERATING ENERGY AND/OR FORCE FROM THE THERMAL MOTION OF GAS MOLECULES

(71) Applicant: Tom Yuxin ZHU, Hoffman Estate, IL (US)

(72) Inventor: Tom Yuxin ZHU, Hoffman Estate, IL (US)

(21) Appl. No.: 17/131,381

(22) Filed: Dec. 22, 2020

Related U.S. Application Data
(60) Provisional application No. 62/953,463, filed on Dec. 24, 2019.

(51) Int. Cl. H02N 2/18

(52) U.S. Cl. CPC H02N 2/18; H02N 1/06

(57) ABSTRACT

The present invention relates to a method and apparatus for generating force from the thermal motion of gas molecules impacting on an article, such as, a plate. It utilizes different surface of the plate, thereby creating differential force between the two different surfaces under the impact of thermal motion of gas molecules around the article. One of the two surfaces is a high loss surface, and the other is a low loss surface so that the article so treated may produce the differential force between two surfaces of the article through the impact of the thermal motion of the gas molecules around the article. Therefore, the differential force between the two surfaces is generated passively through the high loss surface with respect to the other low loss surface of the article.

### FIELD OF THE INVENTION

The present invention relates to a method and apparatus for generating energy and/or producing force from the thermal motion or movement of gas molecules, and more particularly it relates to utilizing different treatments of surface or surfaces of a piece of an article, such as a plate, thereby creating differential force between the surfaces of the article being so treated differently under the impact of thermal motion or movement of gas molecules around the article, such as, in the air or other gases.

### BACKGROUND OF THE INVENTION

Nowadays, people are trying to find out any suitable and sustainable energy resources substituting coal, wood, oil and natural gas, etc., especially any clean energy that would support our energy consumption more efficiently without much pollution issues. Among the resources, solar and wind energies have been adopted more and more in our daily life; and one of other alternative approaches may be seen in U.S. Pat. No. 8,794,930B2 and U.S. Pat. No. 9,845,796B2 of Sanchez et al which describe a device or apparatus to propel a gas, that uses means for heating and/or cooling at least two layers in a stack so as to produce differential force between the two layers through the temperature difference between the two layers. The temperature difference still needs to be actively produced with the consumption of external energy, for example electricity; and thus, it may not be a good substitute energy resource either.

### SUMMARY OF THE INVENTION

The present invention, however, may produce the differential force between two layers or surfaces of an article through thermal motion or movement of gas molecules around the article or produce difference of gas temperature between the two surfaces passively through a high loss surface of the article with respect to another low loss surface thereof to lower the rebound speed of gas molecules, thereby producing a differential force between the two surfaces. According to the present invention, a high loss surface is a surface that will cause higher kinetic energy loss of the gas molecules that collide with the surface, and therefore, the rebound speed of the gas molecules after the collision with the surface is lower than the initial speed before the collision; and a low loss surface is a surface that will cause substantially no kinetic energy loss of the gas molecules that collide with the surface, and therefore the rebound speed of the gas molecules after the collision with the low loss surface is substantially the same as the initial speed before the collision. The low loss surface is generally a common or ordinary surface without special treatment. Typically, a smooth solid surface, for example, a polished silicon wafer surface, a polished steel surface, a polished aluminum surface, etc. may be viewed as a low loss surface. A low loss surface may also include such a surface that will result higher rebound speed, for example, a surface at higher temperature than the temperature of the initial gas molecules. The high loss surface and the low loss surface are the relative terms here as one of the two surfaces would cause higher kinetic energy loss of gas molecules when colliding thereon than the other surface, while the rebound speed of gas molecules after the collision would be lower than the other surface. In other words, if the two surfaces have a noticeable difference in the kinetic energy loss of the gas molecules when colliding with the surfaces, the surface that is of higher kinetic energy loss of the gas molecules is called a high loss surface, and the other surface is called a low loss surface.

According to the present invention, the differential force is generated or produced through means for creating different thermal accommodation coefficient on the surfaces, that is, different interactions between the surface or surfaces of the article and the gas molecules surrounding or around the article when the gas molecules collide to the surface or surfaces.

According to one embodiment of the present invention, the means for creating or generating energy and/or differential force is a piece of an article, such as a plate in any shape or dimension; and at least one of two surfaces of the article is treated with a special coating of polymers or macromolecules to absorb some kinetic energy of the gas molecules colliding with the coating, thereby lowering the rebound speed of the gas molecules after the collision so that such treated surface would be a high loss surface with respect to the other surface thereof as a low loss surface.

According to the second embodiment of the present invention, at least one of the two surfaces of the article is provided with a plurality of micro or nano size micro electro mechanical devices to damp the impact of the gas molecules colliding with the devices, thereby lowering the rebound speed of the gas molecules after the collision to create a high loss surface with respect to another surface thereof as a low loss surface. That is, such micro electro mechanical devices convert some kinetic energy of the gas molecules that collides with the devices to electricity.

According to the third embodiment of the present invention, at least one of the two surfaces of the article is provided with a plurality of micro or nano poles or holes throughout the one surface to create a high loss surface with respect to another surface thereof as a low loss surface.

As further alternatives, one of the two surfaces of the article, such as a plate, may be treated partially with a special coating of polymers or macromolecules on half; and the opposite surface may also be treated partially with the same material on other half; while the treated portions at the opposite surfaces are at opposite sides of the plate. For example, the treated portion on the surface facing up is on the left portion of the plate, while, the treated portion on the surface facing down is on the right portion of the plate.

Still further, one of the two surfaces of the article, such as a plate, may be provided partially with a plurality of micro electro mechanical devices on a portion of the surface; and the other surface may be provided partially with the same micro electro mechanical devices on a portion of the surface; while the such portions of the two surfaces with micro electro mechanical devices are at opposite sides of the plate.

Moreover, one of the two surfaces of the article, such as a plate, may be provided partially with a plurality of micro or nano poles or holes on half; and the other surface may be provided partially with the such micro or nano poles or holes on the other half of the plate; while such portions provided with micro or nano poles or holes would not overlap with each other.

### BRIEF DESCRIPTION OF DRAWINGS

FIG. 1 illustrates the principle of the invention and the first embodiment of the present invention with differently treated surfaces.

FIG. 2 illustrates an alternative of the first embodiment of the present invention with portions of the surfaces being treated differently.

FIG. 3A illustrates the second embodiment of the present invention with a plurality of micro electro mechanical devices provide throughout the plate.

FIG. 3B shows the circuit schematics of a preferred embodiment of the micro electro mechanical device based on piezoelectric generator used in the second embodiment of the present invention.

FIG. 3C illustrates the piezoelectric generator of the present invention.

FIG. 4 shows an alternative of the second embodiment of the present invention having such micro electro mechanical devices provided half-half or partially with two arrays or arrangements of such micro electro mechanical devices on the opposite sides of the two surfaces of the plate.

FIG. 5 illustrates the third embodiment of the present invention having one of the two surfaces of the plate provided with micro or nano poles or holes throughout.

FIG. 6 shows an alternative of the third embodiment of the present invention having a plurality of micro or nano poles or holes in an array provided on a part or half of one of the two surfaces of the plate, and a plurality of micro or nano poles or holes in another array provided on a part or half of the other surface of the two surfaces of the plate.

FIG. 7 illustrates a further alternative embodiment of the present invention in which a plurality of through holes are provided on the plate, on which the aforesaid three embodiments of the present invention can be implemented on the surfaces.

### DETAILED DESCRIPTION OF THE INVENTION

The present invention can be better explained or understood with the followings.

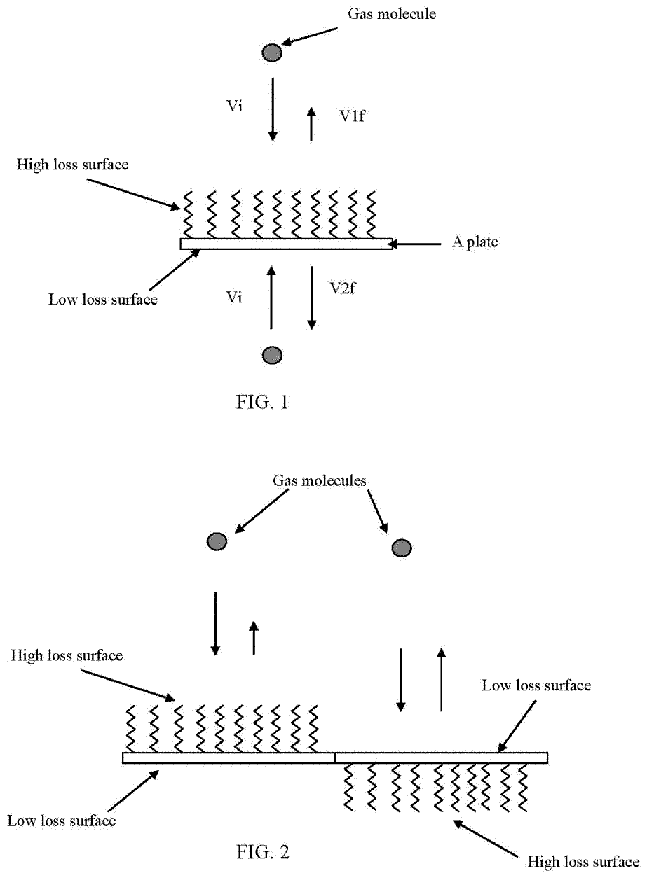

With reference to FIG. 1, it shows the side view of the article or plate, which is positioned in air or a mixture of gaseous fluid or a gas environment, with two surfaces, i.e., a first or upper surface and a second or lower surface. FIG. 1 illustrates the collisions of gas molecules surrounding or around the plate on the upper side and lower side respectively. Gas molecules in any kinds of gases always keep on moving which is called thermal motion, and thus, the speed of the incoming gas molecule is Vi. For the collision on the low loss surface, the rebound speed of the gas molecule is V2f, wherein V2f≈Vi. However, according to the present invention, at least one of the two surfaces is undertaken some kind of surface treatment so that the treated surface may have a high loss surface effect as compared with the other surface that is not treated or is treated differently to have low loss surface effect. For the collision of gas molecules on the high loss surface, the rebound speed of the gas molecule is V1f, as such, V1f<Vi and V1f<V2f. Therefore, the force exerted on the lower side low loss surface of the article or plate caused by the collisions of gas molecules thereon is larger than the force occurs on the upper side high loss surface. The plate would experience a net upward force. The hair or wave lines shown in FIG. 1 represent the high loss surface of the article or plate, that is, the surface so as treated being capable of absorbing the kinetic energy of the gas molecules during the collision. The surface treatment may use various coatings, such as, polymer material, macromolecules, or long chain molecular materials.

The reason of how the differential force on the two sides of surfaces with high loss and low loss surface effect is generated or occurs on the two sides may be explained hereinafter. The force on a surface, e.g. the wall of a container filled with gas, or a plate in the gas, due to the collision of a gas molecule is given by the following equation:

$${F}_{j} = \frac{m {v}_{j i} + m {v}_{j f}}{Δ {t}_{j}} \qquad ( 1 )$$

Where, Fⱼ is the average force during the collision on the wall due to the collision of gas molecule j, m is the mass of the gas molecule, vⱼᵢ is the initial speed, i.e. the incoming speed before the collision, of the gas molecule j, v_{jf} is the final speed, i.e. the rebound speed after the collision, of the gas molecule j, □□tⱼ is the duration time of the collision of the gas molecule j. For simplicity of the writing, here we consider only the speed component in the direction perpendicular to the surface under the consideration.

The total force F on the surface is the sum of the forces due to all collisions of gas molecules to the surface as expressed with equation (2). Force per area is the pressure P, which is the so-called gas pressure.

$$F = {\sum }_{j} \frac{m {v}_{j i} + m {v}_{j f}}{Δ {t}_{j}} \qquad ( 2 )$$

For an individual collision, the force is affected by the duration time of the collision. However, for the sum of the collision of many molecules, since the number of collision is very large, the effect of the change of the duration time is substantially irrelevant, because, for example, for given incoming and rebound speeds, if the duration time is double, according to equation (1), the force will be reduced by half. However, doubling the duration time means that at a given time, the number of molecules in collision is also doubled. The net result is that force, according to equation (2) has no change. Therefore, in the following description, for simplicity without affecting the result, we will not mention the duration time anymore.

The speed of the gas molecules depends on the temperature. The root mean square speed v of the gas molecules is given by equation (3):

$$v = \sqrt{\frac{3 k T}{m}} \qquad ( 3 )$$

Where, k is the Boltzmann constant, T is the temperature of the gas, and m is the mass of the gas molecule.

Therefore, for an initially given, i.e. before the collision gas temperature, the gas pressure depends on the rebound speed of the gas molecules after the collision with the surface.

The rebound speed of a gas molecule depends on if gas molecule has any kinetic energy loss during the collision. If there is no kinetic energy loss, the rebound speed after the collision will equal to the initial speed before the collision. If there is kinetic energy loss, the rebound speed will be smaller than the initial speed, and the force will be smaller than if there is no or less kinetic energy loss. Therefore, we may obtain different force or pressure on the two surfaces or two regions of one surface in the same gas by the manipulation the interactions between the gas molecules and the surface, i.e. the thermal accommodation coefficient.

FIG. 2 shows an alternative of the first embodiment of the present invention, wherein the surface treatments are provided on a portion or half of the article or plate on one side, such as upper surface, and provided on a portion or half of the article or plate on the other side, such as, lower surface. The portions or halves being treated are not on the same portion or half of the plate. As it can be seen in such a side view (or cross-section view) of a plate, the plate now has low loss surfaces and high loss surfaces on both sides of the plate surrounded or immersed in a gas. The collision of gas molecules on the both sides of the plate are substantially the same, though only the collision on one side is illustrated in the figure. The rebound speed of the gas molecules from the high loss surface is smaller than that from the low loss surface. Therefore, the force on high loss surface is smaller than on the force on the low loss surface. The differential forces will produce a torque that will or tend to cause a movement of rotation of the plate clockwise (as shown in FIG. 2), and this rotation can drive a generator to produce electricity, i.e. to produce useful energy, or to do other works.

Considering a plate in the air or other gases, the left half surface and the right half surface are different in the aspect of the collision of gas molecules, such that the gas molecules have different amount of kinetic energy loss in collisions on these two surfaces. Because the initial gas molecules before the collision are identical for the left half surface and the right half surface, the forces on the left half surface and on the right half surface will be different because of different rebound speed. Therefore, there will be a net torque on this plate, as shown in FIG. 2. There can be also generated with both net force and torque. For example, if only the upper side has a portion or half is the high loss surface, and the entire lower side is the low loss surface, we will have a net upward force and a clockwise torque.

The loss of kinetic energy of a gas molecule in the collision with surface is absorbed by the molecule(s) or atom(s) of the surface, which makes those molecule(s) or atom(s) in an excited state, e.g., having stronger vibrations. We may view that those molecule(s) or atom(s) are at a very localized higher temperature. Usually; the gain of the energy by those molecule(s) or atom(s) on the surface will be transferred to the gas molecule of the future collision, which will make the gas molecule has higher rebound speed, therefore, larger force of the collision. On an average, the lost and gain of the kinetic energy in the collisions is substantially the same. Therefore, the collision of the gas molecules is called quasi-elastic collision. For such collision, there is substantially not any difference in the force between the surfaces even if there are different thermal accommodation coefficients on the surfaces.

However, measurements can be taken to make the collisions of gas molecule no longer the quasi-elastic collision. As said above, for those molecule(s) or atom(s) on the surface that has gained the energy from the gas molecule in the collision, and are in the excited state, those molecule(s) or atom(s) will not be in the excited state forever. After a period, those molecule(s) or atom(s) will release the energy that is gained from the collision, and return back to the un-excited state. The energy can be released through the infrared radiation, which is called photon relaxation, or through heat conduction of the surface and substrate material, e.g. crystal lattice of the material of the plate, which is called phonon relaxation. Typically, the time for the relaxations to occur is around the order of nano-second.

Therefore, if the time interval between the two consecutive collisions on those molecule(s) or atom(s) is longer than the relaxation time, the energy that absorbed by those molecule(s) or atom(s) on the surface will not be transferred to gas molecule of the future collision. Therefore, it will be no longer the quasi-elastic collision. There will be net kinetic energy loss of the gas molecule, and net force difference between the surfaces of different thermal accommodation coefficients.

The number of collisions of gas molecules on a given area of the surface in a given time can be estimated by equation (4) for idea gas.

$$Z = \frac{p}{\sqrt{2 π m k T}} \qquad ( 4 )$$

Where p is the pressure of the gas. Therefore, we can always make the interval of the two consecutive collisions longer than the relaxation time by adjusting the pressure and temperature of the gas. At a given temperature, the interval of two consecutive collisions is larger for lower gas pressure. Therefore, lower gas pressure is often desirable in order for the high loss surface to be effective.

Because the gas temperature is related to the average speed of the thermal motion of the gas molecules, the net loss of the kinetic energy of the gas molecule in the collision result lower rebound speed, therefore lower temperature of the gas. For a plate in the gas, the surface that has relatively higher kinetic energy loss of gas molecule in the collision than the opposite surface will have a lower gas temperature near the surface, therefore, there will be a difference in the gas temperature for the gas near the two opposite surfaces if one side is the high loss surface and the opposite is the low loss surface. The phonon relaxation of those excited molecule(s) or atom(s) on the surface will dissipate the energy that is absorbed from the kinetic energy of the gas molecules as heat that is conducted away by the plate. If the plate is made material of high thermal conductivity, the temperature difference within the plate will be negligible.

According to the principle of Einstein effect, the force difference due to the difference in gas temperatures at the two sides of a plate is significant only on the surface near the edge of the surface within the dimension of the mean free path of the gas. Therefore, to be efficient, the dimension of the plate should not be much larger than the mean free path of the gas. A practical device could be a plate that is formed by multiple small size surfaces with opening between them, as shown in FIG. 7.

Another force is the thermal creep force which acts on the edge of the plate is caused by the gas temperature difference at the two opposite surfaces of the plate. The thermal creep force is maximum when the height of the edge, which is the thickness of the plate, is the mean free path of the gas.

Moreover, the force due to the Einstein effect and the thermal creep force are in the same direction. Therefore, we may obtain the differential force for the two opposite sides of a plate. For a practical device, the thickness of the plate is about the mean free path of the gas, and the dimension of each small areas of the surface is about the mean free path of the gas too, which means the dimension between the holes of FIG. 7 is about the mean free path of the gas. The diameter of the holes of FIG. 7 is also about the mean free path of the gas. For a given type of gas molecules and at a given temperature, the mean free path of the gas depends on the gas pressure. The lower the gas pressure, the larger the mean free path of the gas.

The kinetic energy loss in the collision on the high loss surface becomes more significant for heavy gas molecules, for example, xenon (Xe, molecule weight 131 g/mol), sulfur hexafluoride (SF₆, molecule weight 146 g/mol), uranium hexafluoride (UF₆, 352 g/mol), perfluorocarbon (e.g. FC-72, 338 g/mol). However, the apparatus of the present invention may produce a differential force or to generate an energy due to the different surface treatments in the air or other gases. For instance, such gas or mix of gases may have a molecular weight of more than 28 gram/mol; or usually more than 100 gram/mol; as well as 300 gram/mol.

The coating is polymers or large size molecules, including hydrocarbon type materials and silicone type materials. The coating of these materials has the molecular segments in the length of a few tens to hundreds of carbon-carbon atom chains for hydrocarbon-based materials as the coating, or silicon-oxygen atom chains for silicone as the coating material, and those segments are on the surface of the coating like hair on the skin.

Let us use the polymer with carbon-carbon backbone to describe the mechanism. With light gas molecules, for example, hydrogen, helium, nitrogen, and oxygen etc., the mass of the gas molecule is comparable to the atom on the polymer. When the gas molecule collides to the atom on the polymer, the collision is substantially a collision between the gas molecule and the carbon atom or carbon-hydrogen atoms of the polymer, and is not much relevant to the other atoms of the polymer, because mass of the gas molecule is comparable to the carbon atom or the carbon-hydrogen atom that the gas molecule collides with, and the gas molecule is bounced back once upon the collision with carbon atom or carbon-hydrogen atoms. Such collision is very close to the elastic collision, and does not have much energy transfer in the collision. Secondly, the energy that the carbon atom or carbon-hydrogen atoms of the polymer has absorbed in the collision can be easily transferred to the gas molecule of the next collision. Therefore, the average effect is the quasi-elastic collision, which has substantially no net energy loss or gain on average of the collisions between the gas molecules and the surface.

The situation is different when the gas molecule is much heavier than the carbon atom. The collision between the heavy gas molecule and a carbon atom or a pair of carbon-hydrogen atoms of the polymer is not enough to bounce the heavy gas molecule back, instead, the heavy gas molecule will continue to move forward to collide with more atoms on the polymer before the heavy gas molecule stop moving forward and bounces back eventually. Multiple atoms are involved in the collision, and absorb the kinetic energy of the gas molecule. After the collision, some atoms on the polymer might have absorbed some kinetic energy from the heavy gas molecule, and are in excited state. However, in order to give the absorbed energy back to this gas molecule or the gas molecule of the next collision, these atoms on the polymer need to have synchronized motions in time and in direction, which is impossible. Therefore, the heavy gas molecule will have much larger kinetic energy loss than light gas molecule in collision with such polymer coated surface. Only a small portion of the initial kinetic energy can be transferred back to the heavy gas molecules. A large portion of the energy is dissipated through either photon relaxation and phonon relaxation. Because the speed of the rebound gas is lower than the initial speed, which means the rebound gas molecules have a lower temperature, and the force exerted on the surface due to the gas collision is also smaller.

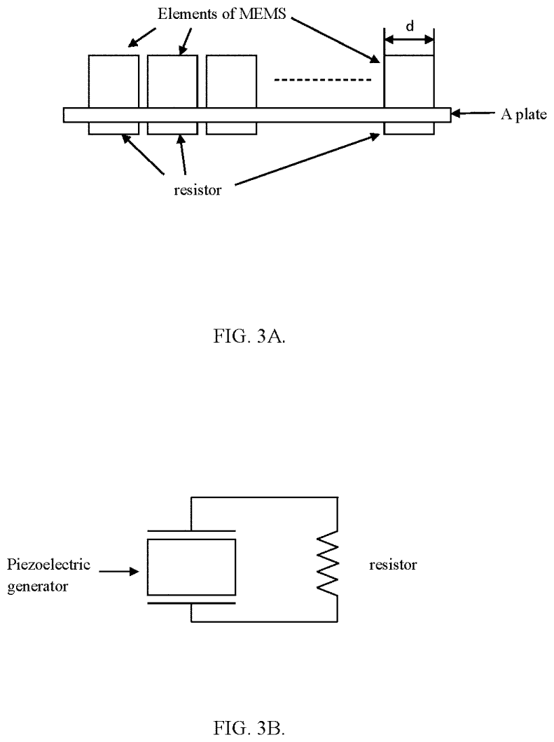

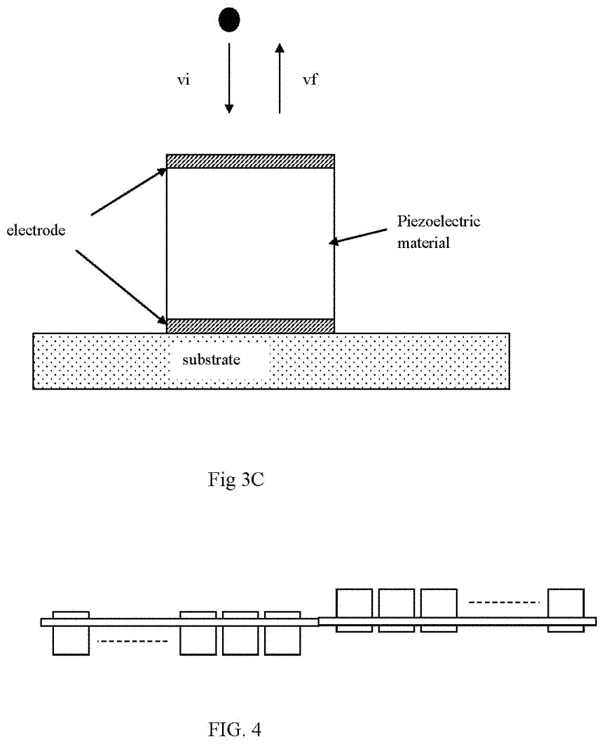

Further, FIGS. 3A and 3B illustrate the second embodiment of the present invention. The high loss surface is implemented with the energy harvesting elements of Micro Electro Mechanical Systems (MEMS) or devices. Each element of the MEMS can absorb the kinetic energy of the gas molecule in the collision to the element of the MEMS. Those MEMS are like nano-size shock absorber that absorbs the kinetic energy from the collision of the gas molecules, reduce the rebound speed of the gas molecule, and converts the energy absorbed into electricity which can be consumed externally, or dissipated on-site as heat on the other side of the plate. The MEMS here can be micro-size electromagnetic generators, electrostatic generators, or piezoelectric generators. The dimension of the generator d is in a range of nano-meter to micro-meter.

FIG. 3C illustrate the side view of a piezoelectric generator. The thickness (i.e. the height) of the piezoelectric material is around a few tens of nanometer to one micrometer. The width of the piezoelectric generator is around a few tens of nanometer to one micrometer.

FIG. 3A shows a side view of the plate that has the elements of MEMS on one side of the plate, and the resistors that each is connected to each element of MEMS respectively on the other side. The elements of the MEMS cover substantially the entire area of that side of the plate, therefore form the high loss surface. The element of the MEMS converts the kinetic energy that is absorbed from the gas molecule to electricity that is dissipated as heat through the resistor on the other side of the plate. The side with resistors is the low loss surface. The heat that is generated by the resistor will be absorbed by the gas molecules that collide with the surface of this side, and gain some speed in the collision, therefore, exerts more force to the surface than if no heat from the resistor, which further enhance the differential force between the two sides of the plate.

FIG. 3B shows the circuit schematic for an element of MEMS which is a piezoelectric generator. The piezoelectric generator can also be replaced with electromagnetic generator or electrostatic generator.

FIG. 4 shows an alternative of the second embodiment of the present invention with the MEMS, which is shown in FIG. 3, to produce torque and rotational motion.

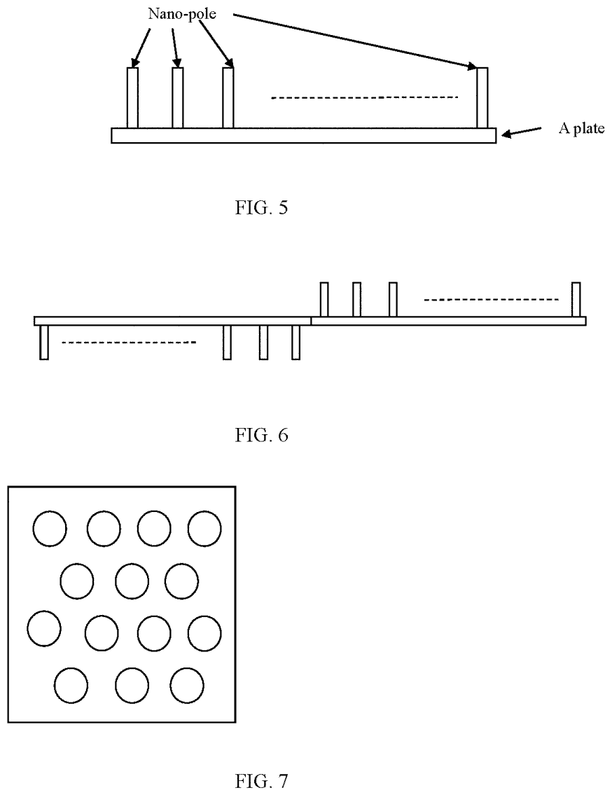

Besides the polymer coating and MEMS, there are still other means to make the high loss surface. For example, nano-structures on the surface, as shown in FIG. 5. For example, nano-size holes on the surface, and the size of the holes are slightly larger than the size of the gas molecule. When the gas molecule collides to surface, the gas molecule moves in the hole, and is colliding with multiple atoms along the holes. Similarly, the nano-structure can also be the nano-size poles with the space between the poles slightly larger than the size of the gas molecules. There could also be combination of the nano-holes and nano-poles, or other nano-structure based on the principle that is described here. The nano-structures provide the friction to the motion of the gas molecules during the collision with the surface, therefore, increase the kinetic energy loss of the gas molecule during the collision with the surface.

FIG. 5 illustrates the third embodiment of the present invention. The high loss surface is implemented with the Micro-structure on one side of the plate. The other side of the plate is the low loss surface. The diameter of the pole is in the range of nano-meter to micro-meter, which can be fabricated with the lithography method. The space between the pole is slightly larger than the size of the gas molecule. The height of the pole is in the order of the size of the gas molecule to tens of the size of the gas molecule. The pole can be circular or other shape, e.g. triangular, square, rectangular, or hexagonal etc. The micro-structure can also be the negative poles. i.e. the holes on the surface of the plate. The size of the holes is slightly larger than the size of the gas molecule. The depth of the hole is in the order of the size of the gas molecule to tens of the size of the gas molecule. The hole can be circular or other shape, e.g. triangular, square, rectangular, or hexagonal etc.

FIG. 6 shows an alternative of the third embodiment of the present invention with the micro-structure on the surface, which is shown in FIG. 5, to produce torque and rotational motion.

Still further in consideration of efficiency, FIG. 7 shows a further alternative embodiment of the present invention, in which a plate for obtaining a differential force (or pressure) between the two opposite sides of the plate. One side of the plate has the high loss surface of the present invention, and the other side is the low loss surface. The circles are the openings on the plate. The diameter the circle is in order of the mean free path of the gas, and distance between two adjacent circles is about twice of the mean free path of the gas, which means the dimension of the area between the circular openings is around the twice of the mean free path of the gas. The thickness of the plate could be about the mean free path of the gas too. Other shape of the opening can also be used, for example hexagonal or square. The means that are describe above for creating high loss surface can be implemented in the area between the through-holes.

1. An apparatus for producing force, comprising a piece of an article having at least two surfaces, at least one of the two surfaces being treated such that the at least one surface is a high loss surface with respect to the other surface as a low loss surface, thereby creating a differential force between the two surfaces to do work or generate electricity, when the article is surrounded or immersed in the air or other gases.

2. The apparatus according to claim 1, wherein said gas or the mix of gases has molecular weight more than 28 gram/mol.

3. The apparatus according to claim 1, wherein said gas or the mix of gases has molecular weight more than 100 gram/mol.

4. The apparatus according to claim 1, wherein said gas or the mix of gases has molecular weight more than 300 gram/mol.

5. The apparatus according to claim 1, wherein said at least one surface is treated with a coating of polymer material, that is capable of absorbing a kinetic energy of gas molecules that collide with the surface covered with the coating.

6. The apparatus according to claim 1, wherein said at least one surface is treated by providing a plurality of micro electro mechanical systems that are capable of absorbing a kinetic energy of gas molecules that collide with the surface being treated, and wherein said micro electro mechanical systems are of 1 nano-meter to 1 micro-meter in size.

7. The apparatus according to claim 6, wherein said micro electro mechanical systems convert the absorbed kinetic energy into electricity.

8. The apparatus according to claim 1, wherein said at least one surface is treated by providing a plurality of nano structures that are capable of absorbing a kinetic energy of gas molecules that collide with the surface of such nano structures, and wherein said nano structures are nano poles or nano holes of 1 nano-meter to 1 micro-meter in size and similar spaces among adjacent ones.

9. The apparatus according to claim 1, wherein only a portion or half of each of surfaces is treated and a portion of half of the other surface is treated similar, thereby providing high loss surfaces and low loss surfaces are provide in pair on opposite sides, to create a torque so that such an article is capable of rotating.

10. A method of creating differential force, comprising the following steps of: (1) providing a piece of an article having at least two surfaces; and (2) treating at least one of the two surfaces such that the said surface becomes a high loss surface with respect to the other surface as a low loss surface, thereby creating a differential force between the two surfaces to do work or generate electricity, when the article is surrounded or immersed in the air or other gases.

11. The method according to claim 10, wherein said gas or mix of gases has molecular weight more than 28 gram/mol.

12. The method according to claim 10, wherein said gas or mix of gases has molecular weight more than 100 gram/mol.

13. The method according to claim 10, wherein said gas or mix of gases has molecular weight more than 300 gram/mol.

14. The method according to claim 10, wherein said at least one surface is treated with a coating of polymer material, that is capable of absorbing a kinetic energy of gas molecules that collide with the surface covered with the coating.

15. The method according to claim 10, wherein said at least one surface is treated by providing a plurality of micro electro mechanical systems that are capable of absorbing a kinetic energy of gas molecules that collide with the surface being treated, and wherein said micro electro mechanical systems are of 1 nano-meter to 1 micro-meter in size.

16. The method according to claim 15, wherein said micro electro mechanical systems convert the absorbed kinetic energy into electricity.

17. The method according to claim 10, wherein said at least one surface is treated by providing a plurality of nano structures that are capable of absorbing a kinetic energy of gas molecules that collide with the surface of such nano structures, and wherein said nano structures are nano poles of 1 nano-meter to 1 micro-meter in size and similar spaces among adjacent ones.

18. The method according to claim 10, wherein both surfaces are treated differently so that one of the two surfaces becomes a high loss surface and the other surface is a low loss surface.

19. The method according to claim 10, wherein only a portion or half of each of surfaces is treated and a portion of half of the other surface is treated similar, while the treated portions on the two different surfaces are not overlapping, thereby providing high loss surfaces and low loss surfaces are provide in pair on opposite sides, to create a torque so that such an article is capable of rotating.
